(19) United States
(12) Patent Application Publication
(10) Pub. No.: US 2017/0344026 A1
(43) Pub. Date: Nov. 30, 2017

(54) UAV, UAV FLIGHT CONTROL METHOD AND DEVICE

(71) Applicant: ZEROTECH (SHENZHEN) INTELLIGENCE ROBOT CO., LTD., Shenzhen (CN)

(72) Inventors: Jianjun YANG, Beijing (CN); Lin YANG, Beijing (CN)

(73) Assignee: ZEROTECH (SHENZHEN) INTELLIGENCE ROBOT CO., LTD., Shenzhen (CN)

(21) Appl. No.: 15/198,073

(22) Filed: Jun. 30, 2016

(30) Foreign Application Priority Data
May 24, 2016 (CN) 201610348101.7

(51) Int. Cl. G05D 1/08; B64C 39/02; G05D 1/00

(52) U.S. Cl. CPC G05D 1/0808; G05D 1/0016; B64C 39/024; B64C 2201/145; B64C 2201/146

(57) ABSTRACT

An unmanned aerial vehicle (UAV), a UAV flight control method and device. The method includes: monitoring a current flight state of the UAV; correcting a flight attitude of the UAV to a preset attitude when the current flight state of the UAV is not consistent with a target flight state; and controlling the flight attitude of the UAV to be a natural hovering attitude when the flight attitude of the UAV fails to be corrected to the preset attitude under a first preset condition.

### TECHNICAL FIELD

Embodiments of the present disclosure relate to an unmanned aerial vehicle (UAV), a UAV flight control method and device.

### BACKGROUND

Currently, a multi-rotor UAV is mainly controlled by a remote controller or a mobile phone.

Usually, a professional operator with certain training can control an attitude of a UAV by changing a throttle rudder amount, an aileron rudder amount, an elevating rudder amount, a direction rudder amount and so on through a remote controller, and can eventually achieve the control of a location and a heading of the UAV. In this case, the control of the UAV needs a user to have a relative high flight operation capability.

For a method of controlling the UAV to arrive at a predetermined position by a mobile phone, in addition to simulating various functions of the remote controller on the phone, an attitude sensor that is built-in on the phone can also be used. By capturing the attitude of the mobile phone through the attitude sensor to control the attitude of the UAV, the control process is relative simple; however, the control accuracy is relative low, and the heading of the UAV cannot be flexibly controlled.

### SUMMARY

Embodiments of the present disclosure provide a UAV flight control method. The method includes: monitoring a current flight state of a UAV; correcting a flight attitude of the UAV to a preset attitude when the current flight state of the UAV is not consistent with a target flight state; and controlling the flight attitude of the UAV to be a natural hovering attitude when the flight attitude of the UAV fails to be corrected to the preset attitude under a first preset condition.

Embodiments of the present disclosure provide a UAV flight control device. The UAV flight control device includes: a flight state monitoring module configured to monitor a current flight state of the UAV; a correction module configured to correct a flight attitude of the UAV to a preset attitude when the current flight state of the UAV is not consistent with a target flight state; and a control module configured to control the flight attitude of the UAV to be a natural hovering attitude when the flight attitude of the UAV fails to be corrected to the preset attitude under a first preset condition.

Embodiments of the present disclosure provide a UAV. The UAV includes: a storage device; a processor; and a UAV flight control device stored in the storage device and including one or more modules executable by the processor. The UAV flight control device includes: a flight state monitoring module configured to monitor a current flight state of the UAV; a correction module configured to correct a flight attitude of the UAV to a preset attitude when the current flight state of the UAV is not consistent with a target flight state; and a control module configured to control the flight attitude of the UAV to be a natural hovering attitude when the flight attitude of the UAV fails to be corrected to the preset attitude under a first preset condition.

### BRIEF DESCRIPTION OF THE DRAWINGS

In order to illustrate the purposes, the technical solutions and the advantages in the embodiments of the present disclosure more clearly, the drawings need to be used in the description of the embodiments will be briefly described in the following; it is obvious that the drawings described below are only related to some embodiments of the present disclosure rather than all the embodiments. All other embodiments made by those skilled in the art without creative efforts on the basis of the embodiments of the present disclosure shall fall within the protection scope of the present disclosure.

FIG. 1 is a schematic block diagram showing a UAV provided by embodiments of the present disclosure;

FIG. 2 is a flow chart diagram showing a UAV flight control method provided by a first embodiment of the present disclosure;

FIG. 3 is another flow chart diagram showing a UAV flight control method provided by the first embodiment of the present disclosure;

FIG. 4 is a flow chart diagram showing a UAV flight control method provided by a second embodiment of the present disclosure; and

FIG. 5 is a functional module diagram showing a UAV flight control device provided by a third embodiment of the present disclosure.

### DETAILED DESCRIPTION

Hereafter, the technical solutions of the embodiments of the present disclosure will be described in a clearly and fully understandable way in connection with the drawings related to the embodiments of the disclosure. It is obvious that the described embodiments are just a part but not all of the embodiments of the present disclosure. The components of the embodiments of the present disclosure described and illustrated in the accompanying drawings here may generally be distributed and designed according to different configurations. Thus, the detailed description on the embodiments of the present disclosure in the accompanying drawings are not intended to limit the protection scope of the present disclosure but are only intended to illustrate the preferred embodiments of the present disclosure. All other embodiments made by those skilled in the art without creative efforts on the basis of the embodiments of the present disclosure shall fall within the protection scope of the present disclosure.

The embodiments of the present disclosure provide a UAV, a flight control method and device for the UAV, in order to solve the above-described problems of low control accuracy and inflexible operation when locating the UAV to a predetermined position.

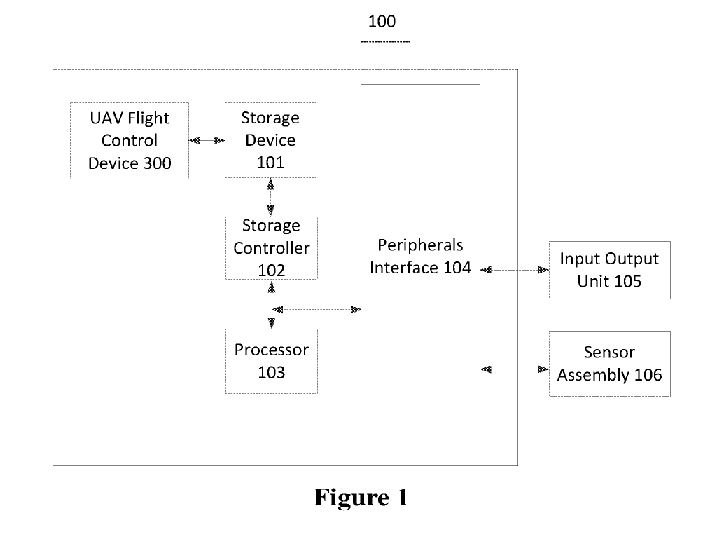

For example, FIG. 1 is an exemplary schematic block diagram of a UAV 100. The UAV 100 includes a UAV flight control device 300, a storage device 101, a storage controller 102, a processor 103, a peripherals interface 104, an input output unit 105, a sensor assembly 106 and other components. The storage device 101, the storage controller 102, the processor 103, the peripherals interface 104, the input output unit 105 and the sensor assembly 106 are directly or indirectly electrically connected with each other, to achieve data communication or interaction. For example, these components are electrically connected with each other through one or more communication buses or signal lines. The UAV flight control device 300 includes at least one software functional module stored in the storage device 101 in a software or firmware form. The processor 103 is configured to carry out executable instructions stored in the storage device 101, e.g., instructions from software functional modules or computer programs included in the UAV flight control device 300.

For example, the storage device 101 can be, but is not limited to, a Random Access Memory (RAM), a Read Only Memory (ROM), a Programmable Read-Only Memory (PROM), an Erasable Programmable Read-Only Memory (EPROM), an Electric Erasable Programmable Read-Only Memory (EEPROM), and so on. For example, the storage device 101 is configured to store programs, and the processor 103 is configured to execute the programs when receiving execution instructions. The methods executed by the UAV as described in any embodiment of the present disclosure can be applied in the processor or can be implemented by the processor 103.

The processor 103 can be an integrated circuit chip having signal processing capability. The above-mentioned processor 103 can be a general purpose processor, including a central processing unit (CPU), a network processor (NP) and so on; and can also be a digital signal processor (DSP), an Application Specific Integrated Circuit (ASIC), a Field Programmable Gate Array (FPGA) or other programmable logic devices, discrete gates or transistor logic devices, discrete hardware assemblies, which can achieve or execute the methods, steps and logic blocks disclosed in the embodiments of the present disclosure. The processor 103 can be a microprocessor, or the processor 103 can be any conventional processor or the like.

The peripherals interface 104 is configured to couple various input/output devices to the processor 103 and the storage device 101. In some embodiments, the peripherals interface 104, the processor 103 and the storage controller 102 can be implemented with a single chip. In other embodiments, they can be implemented by separate chips.

The input output unit 105 is configured to be an interaction interface for a user to provide input data, so that interaction between the user and the UAV 100 is achieved. The input output unit 105 may include, but is not limited to, a press button, an image acquisition device, a voice collecting device and so on for outputting corresponding signals in response to the user's operation.

The sensor assembly 106 is configured to output corresponding signals in response to the user's operation. In the embodiment, the sensor assembly 106 may include, but is not limited to, a voice control sensor, an acceleration sensor, a gyroscope sensor, a barometer, a contact type sensor and so on.

During a UAV flight control process, it often needs to locate the UAV from a position to another position. During the locating process, if the UAV can be directly dragged from its current position to a predetermined position, not only an accurate locating can be achieved, but also the operation is simple and convenient. The UAV flight control method as provided by the embodiments of the present disclosure is used so that a user can directly drag the UAV from its current position to the predetermined position. Hereinafter, the method will be described in details by way of embodiments.

### A First Embodiment

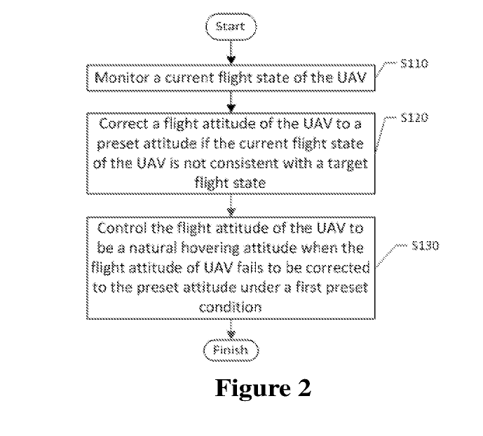

For example, FIG. 2 shows a flow chart diagram of a UAV flight control method provided by a first embodiment of the present disclosure. With reference to FIG. 2, the method includes:

Step S110: monitoring a current flight state of the UAV.

During a flight process of the UAV, the current flight state of the UAV is monitored in real time to determine whether the current flight state of the UAV is inconsistent with a target flight state. For example, the flight state of the UAV includes a flight attitude, a position, a speed or the like of the UAV. In the embodiment, the current flight state is an actual flight state of the UAV currently, and the target flight state is an expected flight state to be achieved by the UAV under the control of a remote control equipment such as a remote controller, a phone, or the like.

It is appreciated that if any one of the flight attitude, the position and the speed is changed, it is determined that the current flight state is not consistent with the target flight state. For example, if the current actual flight attitude of the UAV is not consistent with an expected flight attitude, the current actual position is not consistent with an expected position and/or the current actual speed is not consistent with an expected speed, it is determined that the current flight state is not consistent with the target flight state. For example, the flight attitude includes a pitch angle, a roll angle and a yaw angle of the UAV.

In the embodiment, the flight attitude of the UAV can be monitored by analyzing and processing data obtained from the sensors such as an acceleration sensor, a gyroscope, a compass and so on. The position of the UAV can be monitored by analyzing and processing data obtained from the sensors such as a GPS (Global Positioning System), an ultrasonic sensor, a visual sensor and so on. The speed of the UAV can be monitored by analyzing and processing data obtained from the sensors such as the acceleration sensor, the GPS, the ultrasonic sensor and so on.

Step S120: correcting a flight attitude of the UAV to a preset attitude if the current flight state of the UAV is not consistent with the target flight state.

Generally, the flight state of the UAV can be changed under influence of an external force, which causes the flight state to deviate from the target flight state. In this case, the UAV may be influenced by environmental factors (e.g., wind), and may also be dragged by an external force applied by a user for locating the UAV to a predetermined position.

When the current flight state is not consistent with the target flight state, firstly, the flight attitude of the UAV is corrected to be a preset attitude. The preset attitude can be a target flight attitude, can also be a hovering attitude, and of course, can also be any other flight attitude. There is no limitation placed on the preset attitude in the embodiment. For example, in the embodiment, the hovering attitude is used as the preset attitude.

For example, a rotating speed of rotors in the UAV can be controlled by controlling a control rudder amount, so that the attitude of the UAV is corrected. For example, the control rudder amount includes a throttle rudder amount, an aileron rudder amount, an elevating rudder amount, a direction rudder amount, and so on. A rotor described herein may include an assembly of rotating blades that supplies lift or stability for a UAV. For example, a rotor may be referred to as a rotary wing. The UAV may include one or more rotors.

Step S130: controlling the flight attitude of the UAV to be a natural hovering attitude when the flight attitude of UAV fails to be corrected to the preset attitude under a first preset condition.

It takes time to correct the flight attitude of the UAV. During the correcting process, the correction of the flight attitude can usually be achieved by continuously adjusting the control rudder amount. If it is monitored that the flight attitude can not be corrected to the preset attitude under a certain control rudder amount, then the control rudder amount may be adjusted continuously to change the rotating speed of the rotors, so as to generate a different overcome torque to overcome influence of an external force on the flight attitude. Of course, it is appreciated that adjustment of the control rudder amount includes respective adjustments of the throttle rudder amount, the aileron rudder amount, the elevating rudder amount, and the direction rudder amount based on actual needs.

When the UAV fails to achieve correcting the flight attitude to the preset attitude under the first preset condition, it is determined that the UAV is subjected to dragging of an external force applied by a user for locating the UAV to a preset position. In this case, the UAV stops correcting its flight attitude, and controls the flight attitude of the UAV to be a natural hovering attitude.

It can be appreciated that in the embodiment, the natural hovering attitude of the UAV can be a hovering attitude achieved when the UAV is not subjected to any other external forces except a gravity force, or a hovering attitude achieved when the other external forces acting on the UAV is relative small. The action of the relative small external forces can be an action of external forces possibly generated by wind in the environment.

Furthermore, in the embodiment, controlling the flight attitude of the UAV to be the natural hovering attitude includes controlling the control rudder amount of the UAV to be a control rudder amount when the UAV is in the natural hovering attitude. The control rudder amount when the UAV is in the natural hovering attitude may also be referred to as a natural-hovering control rudder amount. The control rudder amount of the UAV is controlled to be the natural-hovering control rudder amount, so that a rotating speed of the rotors is a rotating speed corresponding to the natural hovering attitude, which enables the user to easily drag the UAV and to easily and quickly locate the UAV to the preset position as expected. Of course, it is appreciated that when the UAV is dragged to the preset position, the heading of the UAV can be determined at the same time.

Of course, a particular natural-hovering control rudder amount can be determined according to actual situation, and can be stored in a storage device in advance. For example, a test flight of the UAV can be performed in a suitable environment without influences of forces that are generated not by the UAV itself but by manual operations (e.g., without influences of forces incurred from manual operations such as dragging of the UAV), and a corresponding control rudder amount when the UAV is at a stable hovering flight state during the test flight process is stored as the natural-hovering control rudder amount.

For example, in an implementation of the embodiment, the first preset condition may include a preset waiting duration. That is, in this preset waiting duration, the control rudder amount of the UAV is changed continuously to correct the flight attitude of the UAV to the preset attitude. When the UAV can not correct its flight attitude to the preset attitude in the preset waiting duration, it is determined that the UAV is subjected to dragging of an external force from the user. In the embodiment, the preset waiting duration can be any value between 0.3 second and 5 seconds; for example, the preset waiting duration can be 1 second. Of course, the preset waiting duration can be any other time value, and there is no limitation placed in the present disclosure.

In another implementation of the embodiment, the first preset condition may include that a difference value between the current control rudder amount and the natural-hovering control rudder amount is larger than or equal with a difference threshold. For example, the difference threshold between the current control rudder amount and the natural-hovering control rudder amount can be configured in advance. During a process when the UAV corrects its flight attitude, the control rudder amount is continuously adjusted; when the control rudder amount is adjusted such that its difference from the natural-hovering control rudder amount is larger than or equal with the difference threshold and the flight attitude of the UAV still cannot be corrected to the preset attitude, it is determined that the UAV is subjected to dragging of the external force from the user. Of course, it is appreciated that for the UAV, during the process when the control rudder amount is continuously adjusted, a corresponding control rudder amount at every moment is a current control rudder amount corresponding to the respective moment.

In addition, since the control rudder amount includes a plurality of rudder amounts such as a throttle rudder amount, an aileron rudder amount, an elevating rudder amount, a direction rudder amount and so on, a corresponding sub-difference threshold can be provided for each of the rudder amounts when setting the difference threshold. And, a sub-difference value of each rudder amount between the current control rudder amount and the natural-hovering control rudder amount is obtained, and the sub-difference value of each rudder amount is compared with the corresponding sub-difference threshold. For example, a sub-difference threshold of the throttle rudder amount is preset; a sub-difference value of the throttle rudder amount between the current control rudder amount and the natural-hovering control rudder amount is obtained; and the sub-difference value of the throttle rudder amount is compared with the preset sub-difference threshold for the throttle rudder amount. For example, the sub-difference value of the throttle rudder amount between (1) the current control rudder amount and (2) the natural-hovering control rudder amount is equal to a difference value between the current throttle rudder amount and a throttle rudder amount when the UAV is in the natural hovering attitude.

For example, when all the corresponding sub-difference values of all the rudder amounts between the current control rudder amount and the natural-hovering control rudder amount are larger than or equal to the corresponding sub-difference thresholds respectively, it is determined that the difference value between the current control rudder amount and the natural-hovering control rudder amount is larger than or equal to the difference threshold. Of course, it is also possible that: when corresponding sub-difference values of a preset quantity of rudder amounts (or some specified rudder amounts) between the current control rudder amount and the natural-hovering control rudder amount are larger than or equal to the corresponding sub-difference thresholds respectively, it is determined that the difference value between the current control rudder amount and the natural-hovering control rudder amount is larger than or equal to the difference threshold.

For example, if between the current control rudder amount and the natural-hovering control rudder amount, at least one of the following requirements (1)-(4) is satisfied: (1) a sub-difference value of the throttle rudder amount is greater than or equal to a sub-difference threshold for the throttle rudder amount; (2) a sub-difference value of the aileron rudder amount is greater than or equal to a sub-difference threshold for the aileron rudder amount; (3) a sub-difference value of the elevating rudder amount is greater than or equal to a sub-difference threshold for the elevating rudder amount; and (4) a sub-difference value of the direction rudder amount is greater than or equal to a sub-difference threshold for the direction rudder amount, then it is determined that the difference value between the current control rudder amount and the natural-hovering control rudder amount is larger than or equal to the difference threshold.

In the embodiment, the difference threshold for the control rudder amount may be 10%; that is, the current control rudder amount is larger than the natural-hovering control rudder amount by at least 10%. For example, in the embodiment, the difference threshold is 60%. Of course, the difference threshold of the control rudder amount can be other suitable values, and there is no limitation placed in the present disclosure. For example, a sub-difference threshold for each rudder amount (e.g., the throttle rudder amount, the aileron rudder amount, the elevating rudder amount and the direction rudder amount) may be 10%, 60%, or any other suitable value.

The embodiment further provides an implementation, and in this implementation, the first preset condition may include that the current control rudder amount is larger than or equal to a rudder amount threshold. That is, a rudder amount threshold is set in advance; during a process when the UAV corrects its flight attitude, the control rudder amount is continuously adjusted; when the control rudder amount is adjusted to be larger than or equal to the rudder amount threshold and the flight attitude of the UAV still can not be corrected to the preset attitude, it is determined that the UAV is affected by dragging of an external force from the user. Moreover, since the control rudder amount includes a plurality of rudder amounts including the throttle rudder amount, the aileron rudder amount, the elevating rudder amount, the direction rudder amount and so on, a sub-rudder-amount threshold can be set for each of the rudder amounts.

For example, the rudder amount threshold includes a sub-rudder-amount threshold for the throttle rudder amount, a sub-rudder-amount threshold for the aileron rudder amount, a sub-rudder-amount threshold for the elevating rudder amount, a sub-rudder-amount threshold for the direction rudder amount and so on; and thus, configuration of the rudder amount threshold includes respective configuration of the sub-rudder-amount threshold for the throttle rudder amount, the sub-rudder-amount threshold for the aileron rudder amount, the sub-rudder-amount threshold for the elevating rudder amount, the sub-rudder-amount threshold for the direction rudder amount and so on. In another example, if the current control rudder amount satisfies at least one of the following requirements (1)-(4): (1) the throttle rudder amount is greater than or equal to the sub-rudder-amount threshold for the throttle rudder amount; (2) the aileron rudder amount is greater than or equal to the sub-rudder-amount threshold for the aileron rudder amount; (3) the elevating rudder amount is greater than or equal to the sub-rudder-amount threshold for the elevating rudder amount; and (4) the direction rudder amount is greater than or equal to the sub-rudder-amount threshold for the direction rudder amount, then it is determined that the current control rudder amount is larger than or equal to the rudder amount threshold.

Furthermore, during a process when the UAV stops correcting its attitude and controls its control rudder amount to be the natural-hovering control rudder amount, the user can easily drag the UAV to the predetermined position. But, after the user locates the UAV at the predetermined position or stops dragging the UAV for other reasons, it is needed to recover the UAV to a normal flight state. In the normal flight state, the UAV flies according to the control of the remote controller or the phone, etc.

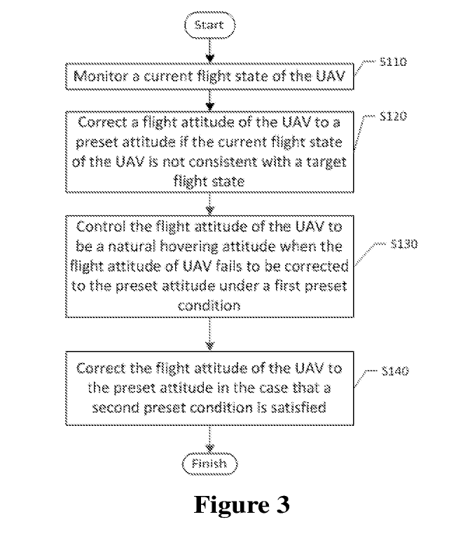

As shown in FIG. 3, in the embodiment the UAV flight control method may further include:

Step S140: correcting the flight attitude of the UAV to the preset attitude in the case that a second preset condition is satisfied.

In order to determine whether or not a user stops dragging the UAV, a second preset condition can be provided. When the second preset condition is satisfied, it is determined that the user has completed dragging of the UAV. In this case, the control rudder amount is changed, and correction of the flight attitude of the UAV to the preset attitude is achieved by controlling the rotating speed of the rotors. Similarly, the preset attitude may be a target flight attitude, may also be a hovering attitude, and may also be any other flight attitude as desired by the user, for example, a flight attitude achievable under the control of a remote control equipment such as a remote controller, a phone or the like. The preset attitude can be set according to practical needs. Of course, in the embodiment, the preset attitude can be a flight attitude achieved by the UAV when the UAV is subjected to the control of a controller; that is, when the second preset condition is satisfied, the flight of the UAV is under control of the controller. It is appreciated that a control rudder amount after the UAV is corrected to the hovering attitude may be different from the natural-hovering control rudder due to influence from the environmental factors or other factors.

In an exemplary implementation provided by the embodiment, the second preset condition may include that the UAV receives a correction signal. The correction signal indicates that dragging on the UAV has been stopped; that is, when the correction signal is received, it is determined that the user stops dragging the UAV, and the UAV can correct its attitude itself.

Furthermore, the correction signal may be inputted through a press button, a voice control sensor, a touch type sensor or an image acquisition device. For example, the UAV is provided with one or more of the press button, the voice control sensor, the touch type sensor or the image acquisition device. The user may send a correction instruction through the press button, the voice control sensor, the touch type sensor, or the image acquisition device; and the press button, the voice control sensor, the touch type sensor or the image acquisition device converts the received correction instruction into a corresponding correction signal which is sent to the processor 103.

For a correction instruction inputted through the voice control sensor, the user may send a specified voice control instruction, e.g., “dragging completed,” and the voice control sensor receives the voice control instruction as the correction instruction and converts the correction instruction into a correction signal to be sent to the processor. For a correction signal inputted through the touch type sensor, usually, a user contacts the UAV when dragging the UAV, and the contact position is selected to be a position used for configuring the touch type sensor; that is, the user contacts the UAV at the position of the touch type sensor (e.g., the user contacts the UAV and the touch type sensor at the same time). When the contact of the touch type sensor is stopped, the touch type sensor sends a signal to the processor as the correction signal. In addition, for the image acquisition device, an instruction can be inputted in a gesture trigger manner, a face trigger manner or the like to obtain the correction signal.

Of course, the correction signal can also be inputted through the remote control equipment such as the remote controller or the like, and there is no limitation placed in the embodiment.

In another implementation provided by the embodiment, the flight attitude of the UAV is periodically corrected to the hovering attitude with a correction time, and the second preset condition may include detecting that the flight attitude of the UAV is already corrected to the hovering attitude.

In this implementation, during a process when the UAV corrects its flight attitude, the UAV is dragged by an external force and its attitude is changed. In order to determine whether or not the dragging of the external force is stopped, the flight attitude of the UAV can be periodically corrected with a correction time in order to correct the flight attitude to the hovering attitude. If one of the corrections succeeds, then it is determined that the dragging is stopped and the second condition is satisfied. Of course, the flight attitude can be corrected to other attitudes, such as a target flight attitude, etc.

For example, the flight attitude of the UAV is periodically corrected with a correction time; that is, the flight attitude is corrected for a short time in every certain time period. For example, in each correction period, the correction of the flight attitude is only performed during the correction time (e.g., the correction time<the correction period). In particular, the correction period can be any value between 0.2 s to 5 s. For example, the correction period is 1 s; that is, the correction of the attitude is carried out every one second. Of course, the correction period can be other time periods, and there is no limitation placed in the present disclosure.

In addition, during the periodical correction process, the correction time in each correction period is very short and is less than or equal to a preset correction duration. In this implementation, the preset correction duration can be any value between 2 ms and 200 ms. For example, the preset correction duration is 10 ms, and the correction time is equal to the preset correction duration.

In addition, the embodiment further provides an implementation, and in this implementation the second preset condition may include that the flight attitude of the UAV keeps unchanged within a preset maintaining duration.

In the case that the control rudder amount of the UAV is the natural-hovering control rudder amount and during a process when correction of the attitude is stopped, if dragging on the UAV is stopped, there is no dragging force and the flight state including the flight attitude, the position, the speed and so on may keep unchanged. In the preset maintaining duration, if the flight state of the UAV keeps unchanged, then it is determined that the user's dragging is stopped and the second preset condition is satisfied. In the embodiment, the preset maintaining duration can be any value between 5 seconds and 1 minute; for example, the preset maintaining duration is 20 seconds.

Of course, it is appreciated that in this implementation, the flight state being kept unchanged does not mean that absolutely no change occurs. Take the influence of the environmental factors into consideration, and in certain situations changes within a certain range are allowed.

In yet another implementation of the embodiment, the step S140 includes: receiving a control signal sent by a remote control equipment; correcting the flight attitude of the UAV to the hovering attitude with a correction time periodically; and when the flight attitude of the UAV is corrected to the hovering attitude, controlling the UAV to fly according to the control signal.

For example, after the UAV receives the control signal sent by the user through the remote control equipment such as a mobile phone or a remote controller for controlling the flight of the UAV, firstly, it is determined whether or not the UAV is dragged by an external force. Whether or not the UAV is dragged by the external force can be determined by correcting the flight attitude of the UAV with the correction time periodically. If the flight attitude of the UAV can not be corrected to the hovering attitude during the periodical correction process, then it is determined that the user is continuously dragging the UAV. In order to ensure safety of the user and the UAV, in this case the control signal is not responded to. Until it is detected that the flight attitude of the UAV is corrected to the hovering attitude, it is determined that the user's dragging is stopped; and in this case, the control signal is responded to and the UAV is controlled to fly according to the control signal. Thus, the UAV is enabled to quickly respond to the flight control from the user.

The UAV provided by the embodiment can be applied in a photo-shooting and filming field. During the shooting process, a shooting position and a shooting angle are key factors to capture ideal shooting images. The shooting position and the shooting angle desired by the user can be obtained by dragging and moving the UAV to a specified shooting position and determining the heading of the UAV at the same time. Then, the user may pose or carry out other activities according to the shooting angle to obtain ideal shooting images.

### A Second Embodiment

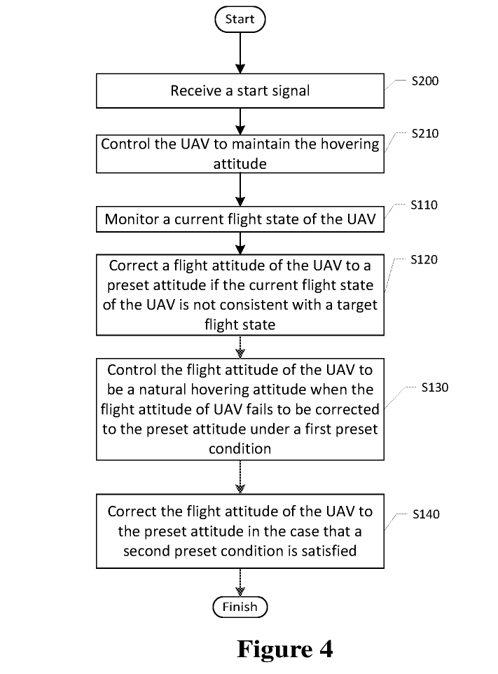

FIG. 4 shows a method for controlling the flight of the UAV provided by a second embodiment of the present disclosure. Compared with the first embodiment, the method provided by the second embodiment further includes, prior to the step S110, a step S200 of receiving a start signal.

Before the user drags the UAV to locate the UAV at the predetermined position, the user first sends a corresponding start instruction to the UAV. For example, the start instruction can be inputted by approaches including a trigger of a press button, a voice control trigger, a touch trigger, a remote control trigger, a gesture trigger, or a face trigger, etc. The UAV receives the start instruction through a corresponding press button, a voice control sensor, a touch type sensor, a remote controller or an image acquisition device, and converts the start instruction into a start signal to be sent to the processor 103.

After the processor 103 receives the start signal, which indicates that the user is possibly going to drag the UAV, a step S110 is started to be carried out in which a current flight state of the UAV is monitored.

Furthermore, since it's easier to contact and drag the UAV when the UAV is at a hovering attitude, then after receipt of the start signal the UAV can be controlled to maintain at the hovering attitude, so that the user can accurately grasp and drag the UAV or drag the UAV in other ways. Accordingly, in the embodiment, as shown in FIG. 4 after the step S200 and prior to the step S110, the method provided by the embodiment further includes a step S210 of controlling the UAV to maintain the hovering attitude.

For example, after receiving the start signal, the UAV is controlled to be at the hovering attitude. When the UAV is stabilized at the hovering attitude, the user can easily determine the position where the UAV is located so as to drag the UAV.

Correspondingly, it is appreciated that the flight attitude corresponding to the target flight state of the UAV can be the hovering attitude. During the process when the UAV is at the hovering attitude, the current flight state of the UAV is monitored. If the UAV is subjected to an external force, the UAV can not maintain stable at the hovering attitude; with respect to the target flight state whose corresponding flight attitude is the hovering attitude, the current flight state of the UAV is changed (that is, the current flight state of the UAV is inconsistent with the target flight state). In this case, the flight attitude of the UAV is corrected to determine whether or not the action of the external force is caused by the user's dragging. Of course, it is appreciated that the external force is an external force that does not include the gravity force.

Furthermore, in the embodiment, when controlling the UAV to be hovering by carrying out the step S210, a control rudder amount when the UAV is at the stable hovering state can be stored. Usually, since the hovering of the UAV in this case is the hovering achieved in a natural state without any dragging force being applied, the stored control rudder amount can be used as the natural-hovering control rudder amount of the UAV.

Furthermore, in the embodiment, in a preset time period after the UAV is controlled to be at the hovering attitude, if dragging by the external force from the user is not detected, then the UAV can continue to fly according to the fight state before the start signal is received. Also, after the start signal is received, a reminder signal can be presented to remind the user to drag the UAV. The reminder signal can be a sound reminder signal or a light reminder signal. Of course, the reminder signal can also be a reminder signal with a combination of sound and light, and there is no limitation placed in the embodiment.

For example, the sound reminder signal can be achieved by a buzzer or the like, but it is not limited thereto. The light reminder signal can be achieved by a LED indication light. For example, the LED indication light can emit light upon receiving the start signal, and can also be changed from one previous color to another color (e.g., from green to red) upon receiving the start signal. Of course, the LED indication light can also be changed from a steady lighting or a steady non-lighting to flickering, and there is no limitation placed in the embodiment. For example, in the embodiment, the reminder signal can be activated after the UAV receives the start signal and is in the hovering attitude, so that the user can be informed of starting to drag the UAV at the time that is suitable for dragging the UAV.

After the start signal is received, when the UAV can not correct its flight attitude to the preset attitude, the flight attitude of the UAV can be controlled to be the natural hovering attitude, to avoid mistaking a situation that the flight attitude of the UAV can not be corrected to the preset attitude under the first preset condition due to the environmental factors (such as wind) to be a situation caused by the user's dragging, and thus to avoid the UAV to be blown away by wind.

### A Third Embodiment

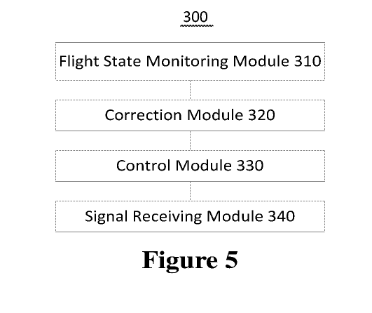

As shown in FIG. 5, the embodiment provides a UAV flight control device 300. The device includes a flight state monitoring module 310, a correction module 320 and a control module 330.

The flight state monitoring module 310 is configured to monitor a current flight state of the UAV. The correction module 320 is configured to correct a flight attitude of the UAV to a preset attitude when the current flight state of the UAV is inconsistent with a target flight state. The control module 330 is configured to control the flight attitude of the UAV to be a natural hovering attitude when the flight attitude of the UAV fails to be corrected to the preset attitude under a first preset condition.

Furthermore, the control module 330 is further configured to control a control rudder amount of the UAV to be a natural-hovering control rudder amount of the UAV to make the flight attitude of the UAV to be the natural hovering attitude.

Furthermore, the correction module 320 is further configured to correct the flight attitude of the UAV to be the preset attitude when a second preset condition is satisfied.

In an implementation of the embodiment, the device further includes a correction signal receiving module configured to receive a correction signal. The correction module 320 uses the correction signal received by the correction signal receiving module as the second preset condition. Also, in the implementation, the correction signal receiving module can receive the correction signal inputted through a press button, a voice control sensor, a touch type sensor or an image acquisition device.

In another implementation of the embodiment, the correction module 320 is further configured to correct the flight attitude of the UAV to be a hovering attitude with a correction time periodically. Furthermore, the correction module 320 can further use a detection by the flight state monitoring module 310, which indicates that the flight attitude of the UAV is corrected to the hovering attitude, as the second preset condition.

In yet another implementation of the embodiment, the device further includes a timing module (not shown in the figures). The correction module 320 uses the flight state of the UAV keeping unchanged within a preset maintaining duration counted by the timing module as the second preset condition.

In addition, in an implementation provided by the embodiment, the control module 330 uses a time out of a preset waiting duration counted by the timing module as the first preset condition.

In another implementation provided by the embodiment, the control module 330 uses a difference value between the current control rudder amount and the natural-hovering control rudder amount of the UAV being larger than or equal to a difference threshold as the first preset condition.

The embodiment further provides an implementation, in which the control module 330 uses the current control rudder amount being larger than or equal to a rudder amount threshold as the first preset condition.

Furthermore, in the embodiment, before dragging the UAV, a start instruction can be sent to the UAV through a corresponding sensor, an image acquisition device, a remote controller or the like in advance, so that the UAV starts monitoring its current flight state. Accordingly, in the embodiment, the device further includes a signal receiving module 340 configured to receive a start signal converted from the corresponding start instruction.

Furthermore, in order to facilitate the user's dragging on the UAV, after the signal receiving module 340 of the UAV receives the start signal, the control module 330 is further configured to control the UAV to maintain the hovering attitude, so as to facilitate the user to drag the UAV when the UAV maintains in the hovering state.

In some embodiments, the above UAV flight control device can be provided on the UAV. For example, each module of the UAV flight control device is provided on the UAV. Of course, in some other embodiments, a part of the above UAV flight control device can be provided on the UAV, and another part of the above UAV flight control device can be provided on the remote controller. For example, some modules of the UAV flight control device can be provided on the UAV and other modules of the UAV flight control device can be provided on the remote controller.

In summary, with the UAV, the UAV flight control method and device provided by the embodiments of the present disclosure, the current flight state of the UAV can be monitored. When the user drags the UAV, the flight state of the UAV is changed, and at the same time, the flight attitude of the UAV is usually changed. The UAV tries to correct its flight attitude to the preset attitude; if the correction fails, it indicates that the UAV is still being dragged by an external force and the user is locating the UAV to a preset position. In this case, the UAV stops correcting its flight attitude, and the flight attitude of the UAV is controlled to be the natural hovering attitude by the remote controller, so as to facilitate the user to easily and quickly drag the UAV to a desirable preset position.

In several embodiments provided by the present disclosure, it should be understood that the disclosed device and method can be implemented in other ways. The device embodiments as described above is only illustrative, for example, the flow charts and block diagrams in the attached drawings show the possible achievable architectures, functions and operations of the device, method and computer program product according to multiple embodiments of the present disclosure. In this aspect, each block in the flow charts or block diagrams may represent a part of a module, a program segment or a code, and the part of the module, the program segment or the code includes one or more executable instructions for achieving specific logic functions. It should be noted that in some alternative implementations, the function indicated by a block can also be carried out in an order different from what is indicated in the attached drawings. For example, in fact, two successive blocks can also be carried out in parallel, and sometimes, they can also be carried out in a reverse order, which can be determined depending on their related function. It is also to be noted that each block in the block diagrams and/or flow charts, and a combination thereof can be implemented with a hardware based system dedicated to carrying out the specified functions or actions, or can be implemented with a combination of a dedicated hardware and computer instructions.

In addition, in the embodiments of the present disclosure, the function modules can be integrated to form an independent part, or may also be separate modules. Or two or more modules are integrated together to form an independent part.

The functions, when implemented in a software function module form and sold or used as an independent product, can be stored in a computer readable storage medium. Based on this concept, the technical solution substantially, or a part contributed to the prior art or a part of the technical solution can be implemented in a form of a computer software product. The computer software product is stored in a storage medium, which includes a plurality of instructions enabling a computer device (e.g., a personal computer, a server, a network equipment, or the like) to carry out all or a part of steps of the method in the embodiments of the present disclosure. The above-mentioned storage medium may include a U disk, a movable hard disk, a Read-only Memory (ROM), a Random Access Memory (RAM), a magnetic disk, an optical disk, or any other medium capable of storing program codes.

It is to be noted that in the context, the relationship terms such as first, second, and so on are used only to distinguish an entity or operation from the other, and do not require or imply any practical relationship or sequence between these entities or operations. Moreover, the terms “include”, “comprise” or its variation are intended to cover non-exclusive inclusion, so that a process, a method, an article or a device including a serious of elements not only includes these elements, but also includes other element not explicitly listed, or further includes the element instinct to the process, the method, the article or the device. The element corrected by the words “includes at least one” does not exclude the inclusion of other same element in the process, the method, the article or the device including the element.

What has been described is only preferred embodiments of the present disclosure, and is not intended to limit the present disclosure, various correction and variation can be made to the present disclosure by the person skilled in the art. All the correction, equivalent substitution, variation, and so on made within the sprit and principle of the present disclosure should fall within the protection scope of the present disclosure. It is to be noted that similar symbols and letters are used in the following attached drawings to indicate the similar items, and therefore, if a certain item is defined in one figure, then its definition and description will be omitted in the following figures.

What has been described above is only the particular embodiments of the present disclosure, but the protection scope of the present disclosure should not be limited thereto, and within the scope disclosed by the present disclosure, many variations or substitutions can be easily conceived by the person skilled in the art, and all the variations and substitutions should be covered by the protection scope of the present disclosure. Therefore, the protection scope of the present disclosure should be defined by the following claims.

The present disclosure claims the benefits of Chinese patent application No. 201610348101.7, which was filed on May 24, 2016 and is incorporated herein in its entirety by reference as part of this application.

What is claimed is:

1. An unmanned aerial vehicle (UAV) flight control method, comprising:
monitoring a current flight state of a UAV;
correcting a flight attitude of the UAV to a preset attitude when the current flight state of the UAV is not consistent with a target flight state; and
controlling the flight attitude of the UAV to be a natural hovering attitude when the flight attitude of the UAV fails to be corrected to the preset attitude under a first preset condition.

2. The method according to claim 1, wherein controlling the flight attitude of the UAV to be the natural hovering attitude comprises: controlling a control rudder amount of the UAV to be a natural-hovering control rudder amount.

3. The method according to claim 1, wherein after controlling the flight attitude of the UAV to be the natural hovering attitude, the method further comprises:
correcting the flight attitude of the UAV to be the preset attitude in the case that a second preset condition is satisfied.

4. The method according to claim 3, wherein the second preset condition includes receiving a correction signal inputted through a press button, a voice control sensor, a touch type sensor or an image acquisition device.

5. The method according to claim 3, further comprising:
correcting the flight attitude of the UAV to a hovering attitude with a correction time periodically; and
wherein the second preset condition includes a detection that the flight attitude of the UAV is corrected to be the hovering attitude.

6. The method according to claim 3, wherein the second preset condition includes that the flight state of the UAV keeps unchanged in a preset maintaining duration.

7. The method according to claim 3, wherein in the case that the second preset condition is satisfied, correcting the flight attitude of the UAV to the preset attitude comprises:
receiving a control signal transmitted from a remote control equipment;
correcting the flight attitude of the UAV to a hovering attitude with a correction time periodically; and
controlling the UAV to fly according to the control signal when the flight attitude of the UAV is corrected to the hovering attitude.

8. The method according to claim 1, wherein the first preset condition includes a preset waiting duration.

9. The method according to claim 1, wherein the first preset condition includes that a different value between a current control rudder amount and a natural-hovering control rudder amount of the UAV is larger than or equal to a difference threshold.

10. The method according to claim 1, wherein the first preset condition includes that a current control rudder amount is larger than or equal to a rudder amount threshold.

11. The method according to claim 1, wherein before monitoring the current flight state of the UAV, the method further comprises:
receiving a start signal inputted through a press button, a voice control sensor, a touch type sensor or an image acquisition device.

12. The method according to claim 11, wherein a flight attitude corresponding to the target flight state is a hovering attitude, and after receiving the start signal and before monitoring the current flight state of the UAV, the method further comprises:
controlling the UAV to maintain hovering.

13. An unmanned aerial vehicle (UAV) flight control device, comprising:
a flight state monitoring module configured to monitor a current flight state of a UAV;
a correction module configured to correct a flight attitude of the UAV to a preset attitude when the current flight state of the UAV is not consistent with a target flight state; and
a control module configured to control the flight attitude of the UAV to be a natural hovering attitude when the flight attitude of the UAV fails to be corrected to the preset attitude under a first preset condition.

14. The device according to claim 13, wherein:
the correction module is further configured to correct the flight attitude of the UAV to the preset attitude in the case that a second preset condition is satisfied.

15. The device according to claim 13, further comprising:
a signal receiving module configured to receive a start signal.

16. The device according to claim 13, wherein the control module is further configured to control the UAV to maintain hovering.

17. An unmanned aerial vehicle (UAV) comprising:
a storage device;
a processor; and
a UAV flight control device stored in the storage device and comprising one or more modules executable by the processor, wherein the UAV flight control device comprises:
a flight state monitoring module configured to monitor a current flight state of the UAV;
a correction module configured to correct a flight attitude of the UAV to a preset attitude when the current flight state of the UAV is not consistent with a target flight state; and
a control module configured to control the flight attitude of the UAV to be a natural hovering attitude when the flight attitude of the UAV fails to be corrected to the preset attitude under a first preset condition.

18. The device according to claim 13, wherein the first preset condition includes at least one of: a preset waiting duration; a difference value between a current control rudder amount and a natural-hovering control rudder amount of the UAV being larger than or equal to a difference threshold; and the current control rudder amount being larger than or equal to a rudder amount threshold.

19. The device according to claim 14, wherein the second preset condition includes at least one of: receipt of a correction signal; a detection that the flight attitude of the UAV is corrected to a hovering attitude; and the flight state of the UAV keeping unchanged in a preset maintaining duration.

20. The device according to claim 13, wherein the control module controls the flight attitude of the UAV to be the natural hovering attitude by controlling a control rudder amount of the UAV to be a natural-hovering control rudder amount of the UAV.
